(19) United States
(12) Patent Application Publication
(10) Pub. No.: US 2008/0092833 A1
(43) Pub. Date: Apr. 24, 2008

(54) High powered vehicles replacing the flywheel with the fan

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, omitted

(21) Appl. No.: 11/584,442

(22) Filed: Oct. 23, 2006

(51) Int. Cl. F01P 5/10; F02B 75/06; F02D 17/02

(52) U.S. Cl. 123/41.47; 123/192.1; 123/198 F

(57) ABSTRACT

The invention is directed to develop for the high power by means of replacing the flywheel with the ducted fan installed in the front position to convert into the rotating force of said fan connected with the rotating operation of the crankshaft of the engine with the strong force enough to reduce the number of the cylinder in the engine while keeping the driving force as well as the stable condition remain as unchanged.

### FIELD OF THE INVENTION

The present invention is generally directed to developing for the more comfortable engine motor cars with less fuel consumption in the driving operation and with less expensive in the production costs than those of the conventional vehicles.

### BACKGROUND OF THE INVENTION

The restriction on the exhausting gases caused by the driving operation of the vehicles is liable to be strictly imposed lately in anywhere on the global markets in view of the heavy air pollution as well as considerable consumption for fuels. Thus it is necessary for further development for basically improving both design and mechanism of the engine motor cars.

### DESCRIPTION OF THE PRIOR ART

The heavy fuel consumption of the engine motor cars in the driving operation is partially caused with the flywheel which is fitted to the crankshaft to damp out the variations of the torque imparted by the pistons of the engines and which requires appropriate weight entailing heavy fuel consumption enough to produce the centrifugal force serving to level out the fluctuation of the torque produced in the running operation of the engine motor cars.

### SUMMARY OF THE INVENTION

The invention is generally directed to develop for the high powered engine motor cars with less consumption of the fuels as well as vibration than those of any other conventional vehicles by means of substituting the flywheel which is fitted to the crankshaft to damp out the variations of torque caused by the pistons and reducing the number of the cylinder strokes of the engines for the ducted fan installed in a front position on a shaft of the engine directly connected with the rotating operation of the crankshaft of the engine of the motor cars.

It is due to the reason why said fan enclosed in the duct with brim serve to augment the rotating force on the blades of the fan continuously capable of driving the vehicle smoothly even if the longer intervals among the combustion operated in the respective engine strokes may be kept in the absence of the function of the flywheel, as if the propeller driven aircraft is not suffered from vertical vibration despite fewer engine cylinder strokes. Thus, the passengers of the vehicles feel high luxurious feeling in the driving operation in the absence of the flywheel of which weight is required for heavy load in view of the functional objective. Thus, considerable saving for fuels as well as comfortable mind for drivers is available.

Furthermore, the wind stream passed through the duct is directed rearwards to be ejected into atmosphere through the upward passage inside of the engine room in the efflux where the down pressure of the air is liable to force down the car body enabling to stabilize in the running operation.

### BRIEF DESCRIPTION OF THE DRAWINGS

FIG. 1: One example of the cross sectional view of the flywheel less engine applied to this invention.

### DETAILED DESCRIPTION OF THE INVENTION

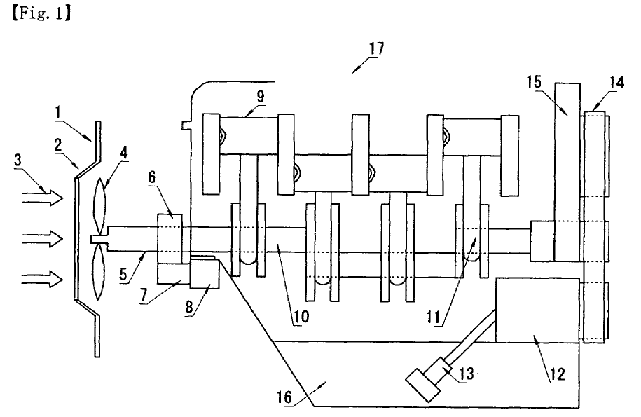

As shown FIG. 1, the present invention is directed to developing for the high powered vehicle with less consumption of fuels as well as smaller vertical vibration caused by the piston (9) operation in the engine than those of the conventional motor cars by means of substituting the flywheel for the ducted fan (4) installed in the front position on the shaft (5) with the ring gear (6) partially processed on its surface converting the head wind (3) into the kinetic energy to directly assist the continuous rotating operation connected with the operation of the crankshaft (10) of said engine (17) where the pressure difference between the wind flow before and after the brim (1) of the duct (2) cause the attractive force to boost the rotating power in the multiplication for the blades of said fan (4). The engine consists of the starter gear (7), the starter motor (8), the pistons (9), the crankshaft (10), the connecting rods (11), the alternator (12), the oil filter (13), the chilled fan (14), the timing belt (15), the oil tank (16) and the like.

The continuous rotating operation of said fan (4) is designed to cover the longer intervals caused with the combustion in the fewer number of the cylinder strokes of the engine (17) in the absence of the flywheel than those of the conventional vehicles as if the passengers of the propeller driven aircraft is prevented from being suffered with the vertical vibration caused by the small number of the cylindrical engine strokes, thus enabling to make avail for comfortable feeling of the drivers in driving operation.

Furthermore, the present invention is directed to stabilize the driving operation of the vehicles by means of flowing the air stream passed through the duct (2) in upward space of the engine (17) room to be ejected into atmosphere, eventually causing the down force on the car body to stabilize the driving operation.

1. The invention is generally directed to developing for the high power vehicles by means of replacing the flywheel with the fan installed in a front position on the rotating shaft connected with the crankshaft of the engine of the vehicle with view to converting the head wind into the additional rotating force for said fan of the engine, thus enabling to reduce the number of the cylinder strokes of the engine while the driving power as well as stable condition remain as unchanged.

2. The rotating force for said fan converted from the head wind provide the sufficient force to reduce the number of the cylinder in the engine of the vehicle while keeping the driving power as well as stable condition may remain as unchanged.

3. The wind flow passed through said duct as well as said fan is directed rearward in the upper space of the engine accommodated room to be ejected into atmosphere, eventually forcing down the car body in running operation to be available for stabilizing condition.
